(19) United States
(12) Patent Application Publication
(10) Pub. No.: US 2010/0207591 A1
(43) Pub. Date: Aug. 19, 2010

(54) VOLTAGE REGULATOR

(76) Inventor: Takashi Imura, Chiba-shi (JP)

Correspondence Address: Brinks Hofer Gilson & Lione/Seiko Instruments Inc., P.O. Box 10395, Chicago, IL, 60611, US

(21) Appl. No.: 12/705,796

(22) Filed: Feb. 15, 2010

(30) Foreign Application Priority Data
Feb. 17, 2009 (JP) JP2009-034321

(51) Int. Cl. G05F 1/00

(52) U.S. Cl. 323/265

(57) ABSTRACT

To provide a voltage regulator having low current consumption.

[Solving Means] In a case of a light load, activation currents flowing through NMOS transistors (22) and (25) to activate a voltage control circuit (92) become substantially zero, and hence the current consumption of the voltage regulator is reduced by a corresponding amount.

### RELATED APPLICATIONS

This application claims priority under 35 U.S.C. §119 to Japanese Patent Application No. 2009-034321 filed on Feb. 17, 2009, the entire content of which is hereby incorporated by reference.

### BACKGROUND OF THE INVENTION

1. Field of the Invention

The present invention relates to a voltage regulator.

2. Description of the Related Art

A conventional voltage regulator is described. FIG. 2 illustrates the conventional voltage regulator.

When an output voltage Vout is higher than a predetermined voltage, that is, when a divided voltage Vfb of a voltage dividing circuit 86 is higher than a reference voltage Vref, a control voltage Vc of an error amplifier 88 is high and a gate voltage of a PMOS transistor 54 is high. Therefore, the driving ability of the PMOS transistor 54 reduces, and hence an operation is performed to lower the output voltage Vout. When the output voltage Vout is lower than the predetermined voltage, an operation reversed from the operation described above is performed to increase the output voltage Vout. Thus, the output voltage Vout becomes constant.

When the PMOS transistor 54 becomes an overcurrent supply state, a current flowing through a PMOS transistor 52 proportionally increases. Then, when a voltage difference at both ends of a resistor 82 increases, an NMOS transistor 61 becomes an on state. When a current flowing through the NMOS transistor 61 increases and thus a voltage difference at both ends of a resistor 81 becomes larger, a PMOS transistor 51 is turned on to increase the control voltage Vc. Then, the driving ability of the PMOS transistor 54 reduces to lower the output voltage Vout. Thus, the element is prevented from being broken by an overcurrent.

Further, the activation of an overcurrent protection circuit is ensured by activation currents of current sources 71 and 72. The PMOS transistors 52 and 53 are current-mirror-connected. When it is assumed that the sizes of the PMOS transistors are equal to each other for simplification of description, gate-source voltages thereof are equal to each other, and hence the currents flowing therethrough are equal to each other. In this case, the current flowing through the PMOS transistor 52 is equal to a current flowing through a PMOS transistor 55. The current flowing through the PMOS transistor 53 is equal to a current flowing through a PMOS transistor 56, and further equal to a current flowing through a PMOS transistor 57 because of the current mirror connection of NMOS transistors 62 and 63. Therefore, the currents flowing through the PMOS transistors 55, 56, and 57 are equal to one another. In this case, gate voltages of the PMOS transistors 55, 56, and 57 are equal to one another. Therefore, source voltages of the PMOS transistors 55, 56, and 57 are equal to one another, and hence the gate-source voltages thereof are equal to each other. Thus, the output voltage Vout (source voltage of PMOS transistor 57) is equal to a voltage Va (source voltage of PMOS transistor 55) and a voltage Vb (source voltage of PMOS transistor 56). In this case, when a difference between a power supply voltage VDD and the output voltage Vout is large, the PMOS transistors 52 to 54 operate in a saturation region. When the difference is small, the transistors operate in a non-saturation region. In any case, the output voltage Vout is equal to the voltage Va and the voltage Vb, and hence the operating states of the PMOS transistors 52, 53, and 54 are identical to one another.

However, in the conventional technology, even when a current flowing from an output transistor is very small because of a light load, that is, even when the operation of the overcurrent protection circuit is unnecessary, the activation currents are supplied from the current sources 71 and 72, and hence the current consumption of the voltage regulator cannot be reduced.

### SUMMARY OF THE INVENTION

The present invention has been made in view of the problem described above, and provides a voltage regulator having low current consumption.

In order to solve the conventional problem, a voltage regulator including an overcurrent protection circuit according to the present invention has the following configuration.

There is provided a voltage regulator including: an error amplifier for making a comparison between a voltage based on an output voltage and a reference voltage; an output transistor which is controlled by a voltage output from the error amplifier; an overcurrent protection circuit including a first sense transistor for sensing an output current from the output transistor; and a voltage control circuit which operates so that a drain voltage of the output transistor is equal to a drain voltage of the first sense transistor, in which the voltage control circuit includes a current circuit for supplying an activation current for activating the voltage control circuit, and the activation current supplied from the current circuit is limited based on the output current from the output transistor.

According to the present invention, when the output current does not flow, the activation current for activating the voltage control circuit does not flow as well, and hence the current consumption of the voltage regulator reduces.

### BRIEF DESCRIPTION OF THE DRAWINGS

FIG. 1 illustrates a voltage regulator according to the present invention.

FIG. 2 illustrates a conventional voltage regulator.

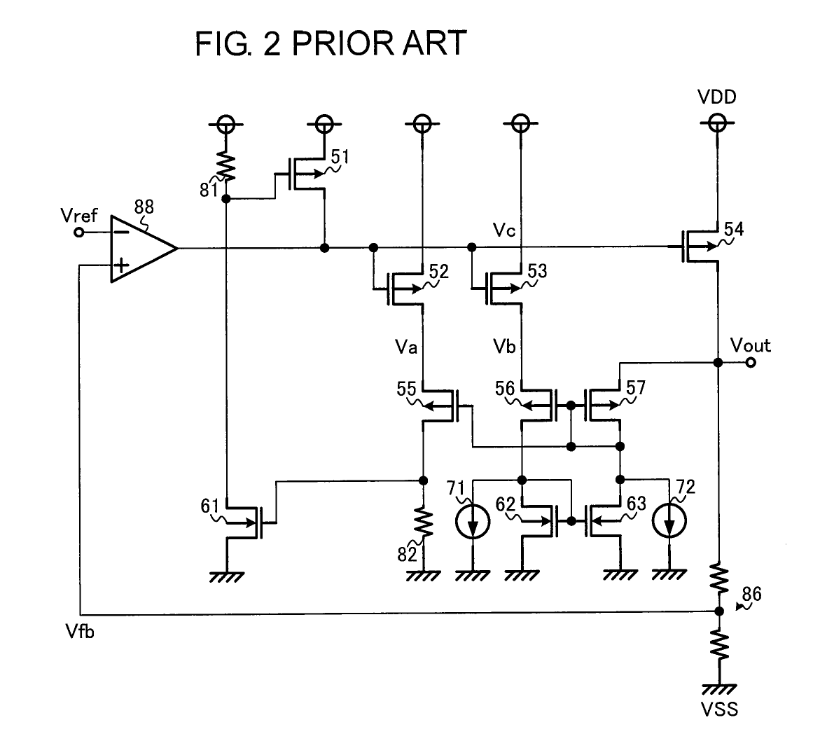

### DETAILED DESCRIPTION OF THE PREFERRED EMBODIMENTS

Hereinafter, an embodiment of the present invention is described with reference to the attached drawing.

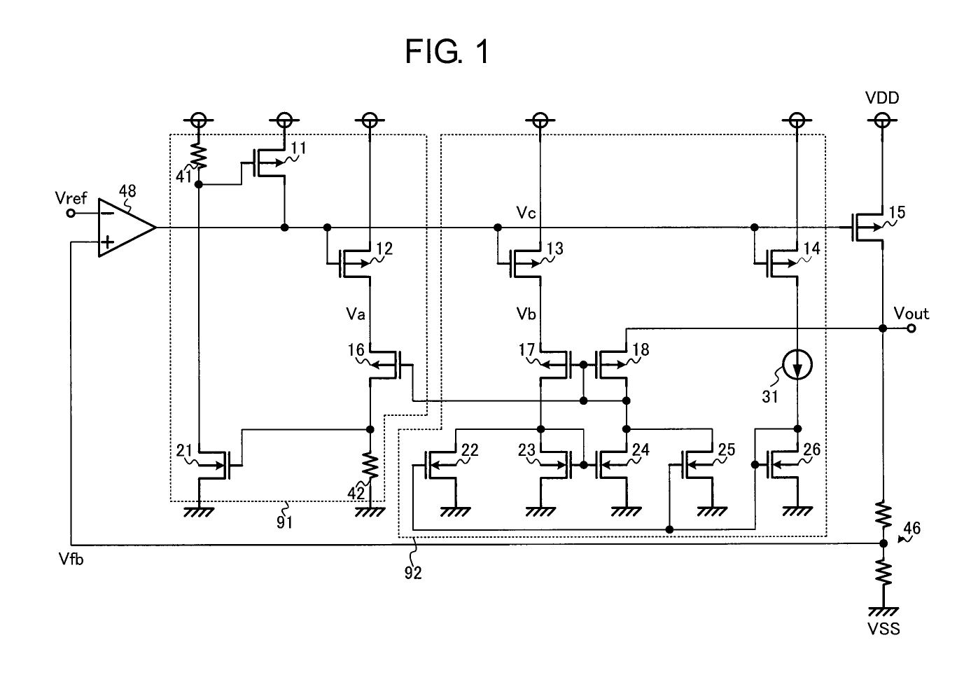

First, a configuration of a voltage regulator is described. FIG. 1 is a circuit diagram illustrating a voltage regulator according to the present invention.

The voltage regulator according to this embodiment includes a PMOS transistor 15, a voltage dividing circuit 46, an error amplifier 48, an overcurrent protection circuit 91, and a voltage control circuit 92. The overcurrent protection circuit 91 includes PMOS transistors 11, 12, and 16, resistors 41 and 42, and an NMOS transistor 21. The voltage control circuit 92 includes PMOS transistors 13, 14, 17, and 18, a current source 31, and NMOS transistors 22, 23, 24, 25, and 26.

A non-inverting input terminal of the error amplifier 48 is connected to an output terminal of the voltage dividing circuit 46, an inverting input terminal thereof is connected to a reference voltage input terminal, and an output terminal thereof is connected to a control terminal of the overcurrent protection circuit 91, a control terminal of the voltage control circuit 92, and a gate of the PMOS transistor 15. A source of the PMOS transistor 15 is connected to a power supply terminal, and a drain thereof is connected to an output terminal of the voltage regulator. The voltage dividing circuit 46 is provided between the output terminal of the voltage regulator and a ground terminal thereof. An input terminal of the voltage control circuit 92 is connected to the output terminal of the voltage regulator, and an output terminal of the voltage control circuit is connected to an input terminal of the overcurrent protection circuit 91.

In the voltage control circuit 92, a gate of the PMOS transistor 13 is connected to the output terminal of the error amplifier 48, a source thereof is connected to the power supply terminal, and a drain thereof is connected to a source of the PMOS transistor 17. A gate of the PMOS transistor 14 is connected to the output terminal of the error amplifier 48, a source thereof is connected to the power supply terminal, and a drain thereof is connected to a drain of the NMOS transistor 26 through the current source 31. A drain of the PMOS transistor 17 is connected to drains of the NMOS transistors 22 and 23. A gate of the PMOS transistor 18 is connected to a drain thereof, a gate of the PMOS transistor 17, and a gate of the PMOS transistor 16 (input terminal of overcurrent protection circuit 91), and a source of the PMOS transistor 18 is connected to the output terminal of the voltage regulator. A gate of the NMOS transistor 23 is connected to the drain thereof and a gate of the NMOS transistor 24, and a source of the NMOS transistor 23 is connected to the ground terminal. A source of the NMOS transistor 24 is connected to the ground terminal, and a drain thereof is connected to the drain of the PMOS transistor 18. A source of the NMOS transistor 22 is connected to the ground terminal. A source of the NMOS transistor 25 is connected to the ground terminal, and a drain thereof is connected to the drain of the PMOS transistor 18. A gate of the NMOS transistor 26 is connected to the drain thereof and gates of the NMOS transistors 22 and 25, and a source of the NMOS transistor 26 is connected to the ground terminal.

In the overcurrent protection circuit 91, a gate of the PMOS transistor 11 is connected to a connection point between the resistor 41 and a drain of the NMOS transistor 21, a source of the PMOS transistor 11 is connected to the power supply terminal, and a drain of the PMOS transistor 11 is connected to the output terminal of the amplifier 48. A gate of the PMOS transistor 12 is connected to the output terminal of the amplifier 48, a source thereof is connected to the power supply terminal, and a drain thereof is connected to a source of the PMOS transistor 16. The resistor 41 is provided between the power supply terminal and the drain of the NMOS transistor 21. The resistor 42 is provided between a drain of the PMOS transistor 16 and the ground terminal. A gate of the NMOS transistor 21 is connected to a connection point between the drain of the PMOS transistor 16 and the resistor 42, and a source of the NMOS transistor 21 is connected to the ground terminal.

It is assumed that a voltage at a connection point between the PMOS transistor 12 and the PMOS transistor 16 is a voltage Va, a voltage at a connection point between the PMOS transistor 13 and the PMOS transistor 17 is a voltage Vb, and an output voltage of the amplifier 48 is a control voltage Vc.

The PMOS transistor 15 serving as an output transistor outputs an output voltage Vout based on the control voltage Vc and a power supply voltage VDD. The voltage dividing circuit 46 divides the output voltage Vout to output a divided voltage Vfb. The error amplifier 48 compares the divided voltage Vfb with a reference voltage Vref and controls the PMOS transistor 15 so that the output voltage Vout becomes a constant voltage. In the overcurrent protection circuit 91, if an overcurrent flowing into the PMOS transistor 15 is sensed by a first sense transistor (PMOS transistor 12), the PMOS transistor 15 is controlled to lower the output voltage Vout. The voltage control circuit 92 operates so that a drain voltage of the PMOS transistor 15 (output voltage Vout) becomes equal to a drain voltage of the PMOS transistor 12 (voltage Va).

The overcurrent protection circuit 91 includes the PMOS transistor 12 for sensing an output current of the PMOS transistor 15. The voltage control circuit 92 includes a current circuit which supplies an activation current for activating the voltage control circuit 92, based on the output current of the PMOS transistor 15. The current circuit includes the PMOS transistor 14 serving as a second sense transistor for sensing the output current of the PMOS transistor 15, a current mirror circuit formed of the NMOS transistors 22, 25, and 26 for receiving a current of the PMOS transistor 14 from an input terminal and supplying the activation current from an output terminal, and the current source 31.

Next, an operation of the voltage regulator according to this embodiment is described.

When the output voltage Vout is higher than a predetermined voltage, that is, when the divided voltage Vfb of the voltage dividing circuit 46 is higher than the reference voltage Vref, the control voltage Vc of the error amplifier 48 (gate voltage of PMOS transistor 15) is high and the driving ability of the PMOS transistor 15 reduces, and hence the output voltage Vout decreases. When the output voltage Vout is lower than the predetermined voltage, an operation reversed from the operation described above is performed to increase the output voltage Vout. Thus, the output voltage Vout becomes constant.

In this case, although described below, the PMOS transistor 16 is in an on state. Then, the output current of the PMOS transistor 15 increases and becomes the overcurrent. A current flowing through the PMOS transistor 12 increases in proportion to the overcurrent to increase a voltage difference at both ends of the resistor 42, and hence the NMOS transistor 21 becomes the on state. When a current flowing through the NMOS transistor 21 increases to increase a voltage difference at both ends of the resistor 41, the PMOS transistor 11 is turned on, and hence the control voltage Vc becomes higher. Then, the driving ability of the PMOS transistor 15 reduces to lower the output voltage Vout. Therefore, the element is prevented from being broken by the overcurrent.

Next, an operation of the voltage control circuit 92 is described.

It is assumed that the NMOS transistors 22, 25, and 26 are equal in size to one another, the PMOS transistors 12 and 13 are equal in size to each other, the PMOS transistors 16, 17, and 18 are equal in size to one another, and the NMOS transistors 23 and 24 are equal in size to each other.

When the output current flows through the PMOS transistor 15, a current also flows through the PMOS transistor 14 because of the current mirror connection of the PMOS transistors 14 and 15. Then, a current from the current source 31 flows, as the activation current, into a connection point between the PMOS transistor 17 and the NMOS transistor 23 because of the current mirror connection of the NMOS transistors 22 and 26. In addition, the current from the current source 31 flows, as the activation current, into a connection point between the PMOS transistor 18 and the NMOS transistor 24 because of the current mirror connection of the NMOS transistors 25 and 26. Therefore, the voltage control circuit 92 is activated.

The PMOS transistors 12 and 13 are current-mirror-connected, and hence gate-source voltages thereof are equal to each other. In this case, a current flowing through the PMOS transistor 12 is equal to a current flowing through the PMOS transistor 16. In addition, a current flowing through the PMOS transistor 13 is equal to a current flowing through the PMOS transistor 17, and further equal to a current flowing through the PMOS transistor 18 because of the current mirror connection of the NMOS transistors 23 and 24. Therefore, the currents flowing through the PMOS transistors 16, 17, and 18 are equal to one another. Then, because the currents flowing through the PMOS transistors 16, 17, and 18 are equal to one another and gate voltages of the PMOS transistors 16, 17, and 18 are equal to one another, source voltages of the PMOS transistors 16, 17, and 18 become equal to one another and gate-source voltages thereof become equal to one another. Thus, the output voltage Vout (source voltage of PMOS transistor 18) is equal to the voltage Va (source voltage of PMOS transistor 16) and the voltage Vb (source voltage of PMOS transistor 17). In this case, when a difference between the power supply voltage VDD and the output voltage Vout is large, the PMOS transistors 12, 13, and 15 operate in a saturation region. When the difference is small, the transistors operate in a non-saturation region. In any case, the output voltage Vout is equal to the voltage Va and the voltage Vb, and hence the operating states of the PMOS transistors 12, 13, and 15 are identical to one another.

When the output current of the PMOS transistor 15 becomes very small, the current of the PMOS transistor 14 also becomes very small because of the current mirror connection of the PMOS transistors 14 and 15. Then, the current source 31 becomes disabled to supply a normal current. Therefore, the activation current flowing into the connection point between the PMOS transistor 17 and the NMOS transistor 23 also becomes very small because of the current mirror connection of the NMOS transistors 22 and 26. In addition, the activation current flowing into the connection point between the PMOS transistor 18 and the NMOS transistor 24 also becomes very small because of the current mirror connection of the NMOS transistors 25 and 26.

When the output current of the PMOS transistor 15 does not flow, the activation current does not flow as well, and hence there is a case where the voltage control circuit 92 may not be activated. However, when the output current of the PMOS transistor 15 does not flow, the operation of the voltage control circuit 92 is unnecessary, and hence the activation of the voltage control circuit 92 may be inhibited.

In the voltage regulator including the voltage control circuit 92 as described above, the activation currents flowing through the NMOS transistors 22 and 25 may be reduced in a case of a light load, and hence the current consumption of the voltage regulator becomes smaller.

What is claimed is:

1. A voltage regulator, comprising:
an error amplifier for making a comparison between a voltage based on an output voltage of the voltage regulator and a reference voltage and outputting a voltage obtained by amplifying a difference therebetween;
an output transistor for outputting the output voltage of the voltage regulator based on the voltage output from the error amplifier and a power supply voltage;
an overcurrent protection circuit including a first sense transistor for sensing an output current from the output transistor, for controlling the output transistor to lower the output voltage of the voltage regulator when an overcurrent from the output transistor is detected by the first sense transistor; and
a voltage control circuit which operates so that a drain voltage of the output transistor is equal to a drain voltage of the first sense transistor,
wherein the voltage control circuit includes a current circuit for supplying an activation current for activating the voltage control circuit, and the activation current supplied from the current circuit is limited based on the output current from the output transistor.

2. A voltage regulator according to claim 1, wherein:
the current circuit comprises:
a current source for outputting a constant current;
a current mirror circuit for inputting the current from the current source and outputting the activation current; and
a second sense transistor for sensing the output current from the output transistor; and
the activation current is limited by the second sense transistor based on the output current from the output transistor.
